(19) United States
(12) Patent Application Publication
(10) Pub. No.: US 2025/0225621 A1
(43) Pub. Date: Jul. 10, 2025

(54) METHOD FOR ADJUSTING VIDEO SIGNAL

(71) Applicant: ASUSTeK COMPUTER INC., Taipei City (TW)

(72) Inventors: Jo-Fan Wu, Taipei City (TW); Ting-Wei Hsu, Taipei City (TW)

(73) Assignee: ASUSTeK COMPUTER INC., Taipei City (TW)

(21) Appl. No.: 18/936,935

(22) Filed: Nov. 4, 2024

(30) Foreign Application Priority Data
Jan. 4, 2024 (TW) 113100479

(51) Int. Cl. G06T 5/50; G06V 10/24; G06V 10/60

(52) U.S. Cl. CPC G06T 5/50; G06V 10/24; G06V 10/60; G06T 2207/20221

(57) ABSTRACT

A method for adjusting video signal is provided. First, a processor is configured to obtain N consecutive input frames obtained by an imaging apparatus. Next, the processor is configured to generate N result frames based on the N input frames, including: storing the first input frame as the first result frame; and selecting a plurality of the N input frames as a source for image-overlaying of the i-th frame according to the time sequence, performing an image-overlaying operation on the selected multiple input frames to obtain the i-th result frame, and storing the i-th result frame. Then, the processor is configured to generate a video signal based on the N result frames.

### CROSS-REFERENCE TO RELATED APPLICATION

This application claims the priority benefit of Taiwan application serial no. 113100479, filed on Jan. 4, 2024. The entirety of the above-mentioned patent application is hereby incorporated by reference herein and made a part of this specification.

### BACKGROUND

### Technical Field

The application relates to an image processing method, and in particular, to a method for adjusting video signal.

### Description of Related Art

In general, during photography of fireworks, since the speed of fireworks spreading in the air is usually slow in the camera scene, the trajectory length of the fireworks is often limited by the length of a single frame exposure. In order to maintain the smoothness of the video in general video recording, the frame rate must be maintained at a certain level of high frame rate (HFR). As a result, the exposure time of a single frame will be limited, so when shooting fireworks videos, you can usually only get a picture of the fireworks points, but cannot record the lines of the trajectory.

If it is necessary to retain the trajectory of a longer fireworks smear, the single frame exposure time needs to be extended. As a result, the output frame rate of the photosensitive element will be reduced, which will affect the smoothness of video playback. Furthermore, even if time-lapse photography technology is used to reduce the display time of a single frame on the video for the sake of smoothness (i.e. changing the sense of time speed to maintain frame rate), however, due to the time-lapse effect, which makes the fireworks fleeting. Therefore, it further affects the user's perception of time during viewing, and the beautiful feeling of slow dragging fireworks cannot be presented.

### SUMMARY

The present invention provides a method for adjusting video signal including: obtaining N consecutive input frames obtained by an imaging apparatus by a processor; and generating N result frames based on the N input frames and generating a video signal based on the N result frames by the processor. The step of generating the N result frames includes: storing a first input frame of the N input frames as a first result frame; and selecting multiple input frames of the N input frames according to a time sequence as a source for image-overlaying of an i-th result frame, performing an image-overlaying operation on the selected multiple input frames to obtain the i-th result frame, and storing the i-th result frame, wherein i=2, 3, 4, . . . , N.

Based on the above, the disclosure uses the video signal originally shot with a short exposure through the image-overlaying operation to obtain the video signal that can simulate the effect of a long exposure. In this way, it cannot affect the smoothness of video playback, but also have a beautiful feeling.

### BRIEF DESCRIPTION OF THE DRAWINGS

FIG. 1 is a schematic diagram of an electronic device according to an embodiment of the present invention.

FIG. 2 is a flow chart of a method for adjusting the video signal according to an embodiment of the present invention.

FIG. 3 is a schematic diagram of generating the output frame based on the input frame according to an embodiment of the present invention.

FIG. 4A to FIG. 4C are schematic diagrams of the input frame in the original video signal obtained by shooting fireworks according to an embodiment of the present invention.

FIG. 5A to FIG. 5C are schematic diagrams of the result frame obtained based on the original video signal according to an embodiment of the present invention.

### DESCRIPTION OF THE EMBODIMENTS

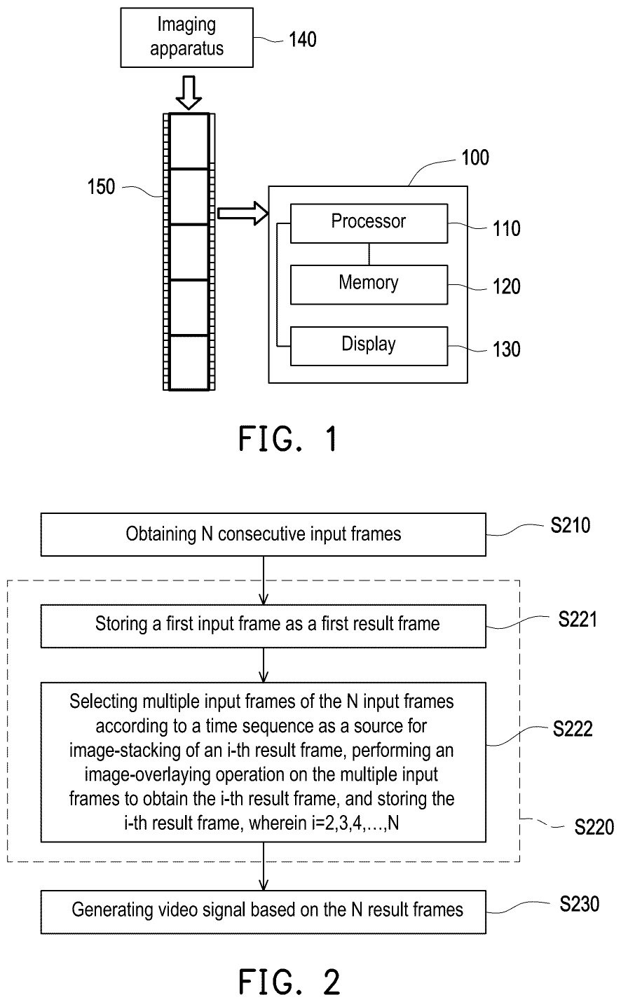

FIG. 1 is a schematic diagram of an electronic device according to an embodiment of the present invention. Referring to FIG. 1, the electronic device 100 is used to further adjust an original video signal 150 obtained by an imaging apparatus 140 to obtain an adjusted video signal with a long exposure effect. In the embodiment, the imaging apparatus 140 is not integrated with the electronic device 100. The imaging apparatus 140 can communicate with the electronic device 100 through wired or wireless means. The wired communication means may use, for example, cables. The wireless communication means may include, for example, Wi-Fi, Bluetooth, etc. However, in other embodiments, the imaging apparatus 140 may also be built inside the electronic device 100, which is not limited thereto.

The imaging apparatus 140 is implemented, for example, by a video recorder, a camera, etc. using a Charge coupled device (CCD) lens or a Complementary metal oxide semiconductor transistors (CMOS) lens. In other embodiments, the imaging apparatus 140 may be further configured with a gyroscope, an accelerometer, a voice coil motor, etc.

The electronic device 100 includes a processor 110, a memory 120 and a display 130. The processor 110 is coupled to the memory 120 and the display 130. The electronic device 100 may be a smart phone, a smart wearable device, a tablet computer, a notebook computer, a personal computer, or other electronic device with computing capabilities.

In addition, in other embodiments, the display 130 may also be an external device that communicates with the electronic device 100 through wired or wireless means. Here, it is not limited whether the display 130 is integrated with the electronic device 100.

The processor 110 is, for example, a Central Processing Unit (CPU), a Physics Processing Unit (PPU), a Microprocessor, an embedded control chip, a Digital Signal Processor (DSP), an Application Specific Integrated Circuit (ASIC), or other similar devices.

The memory 120 includes one or more program code fragments. After the above code fragment is installed, it will be executed by the processor 110 to perform the method of self-adjusting the video signal described below. The memory 120 can be implemented using any type of fixed or removable Random-Access Memory (RAM), Read-Only Memory (ROM), Flash memory, hard disk or other similar devices or a combination of these devices.

The display 130 is used to display the adjusted video signal. For example, Liquid Crystal Display (LCD), Plasma Display, Organic Light-Emitting Diode (OLED) display, projection system, etc. can be used to implement the display 130.

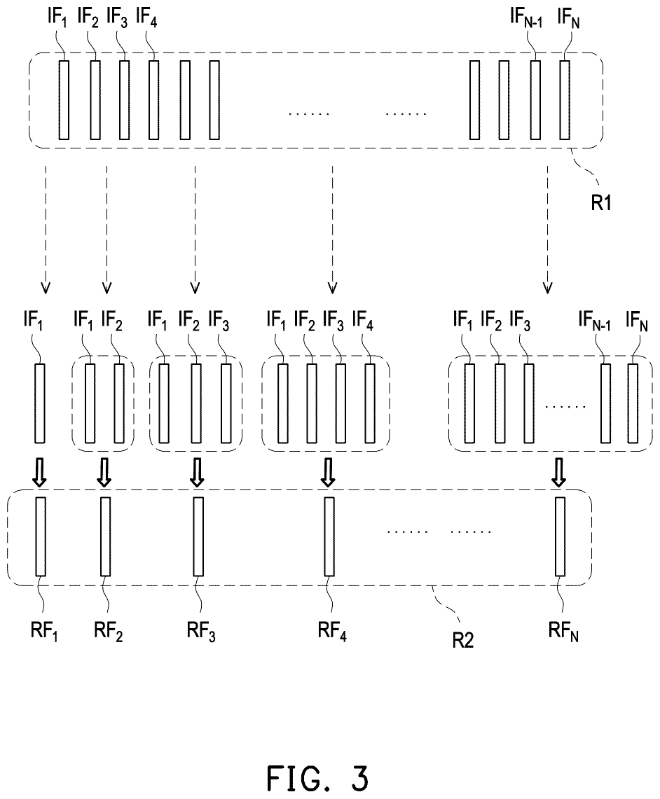

FIG. 2 is a flow chart of a method for adjusting the video signal according to an embodiment of the present invention. FIG. 3 is a schematic diagram of generating the output frame based on the input frame according to an embodiment of the present invention. Referring to FIG. 1, FIG. 2 and FIG. 3, in step S210, the processor 110 obtains N consecutive input frames IF₁ to IF_{N}. For example, the original video signal 150 obtained by the imaging apparatus 140 includes N input frames IF₁ to IF_{N}.

Then, in step S220, the processor 110 generates N result frames RF₁ to RF_{N} based on the N input frames IF₁ to IF_{N}. Specifically, in step S221, the processor 110 stores the first input frame IF₁ as the first result frame RF₁. Then, in step S222, the processor 110 selects multiple input frames in the N input frames IF₁ to IF_{N} according to a time sequence as a source for image-overlaying of an i-th result frame RFᵢ, performs an image-overlaying operation on the multiple input frames to obtain the i-th result frame RFᵢ and stores the i-th result frame RFᵢ, wherein i=2, 3, 4, . . . , N. That is to say, the processor 110 takes out the corresponding multiple input frames for the second result frame RF₂ to the N-th result frame RF_{N} to perform the image-overlaying operation.

For example, FIG. 3 shows a selection method of the source for image-overlaying. In the embodiment, assuming that the original video signal 150 is stored in a first region R1 of the memory 120, the processor 110 may set a second region R2 different from the first region R1 in the memory 120 to store the generated result frame. First, the processor 110 takes out the first input frame IF₁ from the first region R1 as the first result frame RF₁, and stores the first input frame IF₁ to the second region R2.

Then, the processor 110 takes out the corresponding source for image-overlaying for the second result frame RF₂ to the N-th result frame RF_{N}. In the embodiment shown in FIG. 3, the processor 110 selects i input frames IF₁ to IFᵢ in the first region R1 according to a time sequence as a source for image-overlaying of the i-th result frame RFᵢ. And after the image-overlaying operation, the i-th result frame RFᵢ is stored into the second region R2.

Specifically, the processor 110 takes out two consecutive input frames (IF₁ to IF₂) starting from the first input frame IF₁ in the first region R1 as the source for image-overlaying of the second result frame RF₂, then, the image-overlaying operation is performed on the input frames IF₁ to IF₂ to obtain the second result frame RF₂. The processor 110 takes out three consecutive input frames (IF₁ to IF₃) starting from the first input frame IF₁ in the first region R1 as the source for image-overlaying of the third result frame RF₃, then, the image-overlaying operation is performed on the input frames IF₁ to IF₃ to obtain the third result frame RF₃. The processor 110 takes out four consecutive input frames (IF₁ to IF₄) starting from the first input frame IF₁ in the first region R1 as the source for image-overlaying of the fourth result frame RF₄, then, the image-overlaying operation is performed on the input frames IF₁ to IF₄ to obtain the fourth result frame RF₄. By analogy, subsequent result frames (RF₄ to RF_{N}) are obtained.

In other embodiments, continuous or discontinuous Mᵢ input frames can also be taken out based on requirements as the source for image-overlaying of i-th result frame RFᵢ, 1<Mi≤i.

Before performing the image-overlaying operation, the processor 110 can selectively perform an image alignment action or an image stabilization process so that the input frame to be overlaid is aligned. The image alignment operation, for example, uses control points to align the image to the correct position. The image stabilization procedure is described below. The processor 110 uses related image feature calculation technologies such as Digital Image Stabilization (DIS) calculation to calculate the video jitter caused by hand shake, and thereby determine whether the input frame to be overlaid is aligned. Alternatively, the processor 110 uses Electric Image Stabilization (EIS) related technology to process the gyroscope signal of the imaging apparatus 140 to estimate the relationship between the viewing angle change and the input frame, and thereby determine whether the input frame to be overlaid is aligned. Alternatively, the user uses optical image stabilization (OIS) or Gimbal Stabilization related technologies to process the gyroscope signal and accelerometer signal of the imaging apparatus 140 to estimate the degree of rotation or movement of the imaging apparatus 140, and thereby determine whether the input frame to be overlaid is aligned. The above method of judging alignment is only an example and is not limited thereto.

After that, during the image-overlaying operation, the processor 110 respectively retains one or more pixels with a brightness value greater than a preset value (default brightness) for the first input frame to the Mᵢ−1th input frame included in the source for image-overlaying (Mᵢ input frames). Then, the processor 110 overlays the pixels retained from the first input frame to the Mᵢ−1th input frame to the Mᵢth input frame to obtain the i-th result frame RFᵢ.

Alternatively, the processor 110 respectively retains one or more pixels with a saturation value greater than a preset value (preset saturation) for the first input frame to the Mᵢ−1th input frame included in the source for image-overlaying (Mᵢ input frames). Then, the processor 110 overlays the pixels retained from the first input frame to the Mᵢ−1th input frame to the Mᵢth input frame to obtain the i-th result frame RFᵢ.

In addition, the processor 110 may also sum and average each pixel of multiple input frames as the source for image-overlaying to obtain the i-th result frame RFᵢ. Alternatively, the value of each pixel of multiple input frames that are the source for image-overlaying is calculated by adding weights and then averaged. The above is only an example and is not limited thereto.

After that, in step S230, the processor 110 generates the video signal based on the N result frames RF1 to RFN. The processor 110 determines the time interval of the simulated exposure of the N result frames RF1 to RFN based on the frame rate. The processor 110 determines the number of frames per second to play based on the frame rate. Assuming the frame rate is 30 fps (frame per second), it means that the time interval corresponding to each result frame is 1/30 seconds, and the playback time length of the video signal formed by the N result frames is N/30 seconds. The frame rate can be flexibly adjusted based on the exposure length to be simulated.

Herein, the input frames and the result frames can adopt Bayer pattern, RGB raw data, YUV and other data formats. The embodiment uses YUV for processing, however, the data format is not limited thereto. In practical applications, taking the electronic device 100 with the built-in imaging apparatus 140 as an example, after the user obtains the original video signal through photography by the imaging apparatus 140, the processor 110 can perform the overlaying operation on the original video signal in real time and transmit the adjusted video signal to the control circuit of the display 130, so that each result frame is rendered to the display screen through the control circuit based on the time interval (for example, 1/30 seconds) between two adjacent frames.

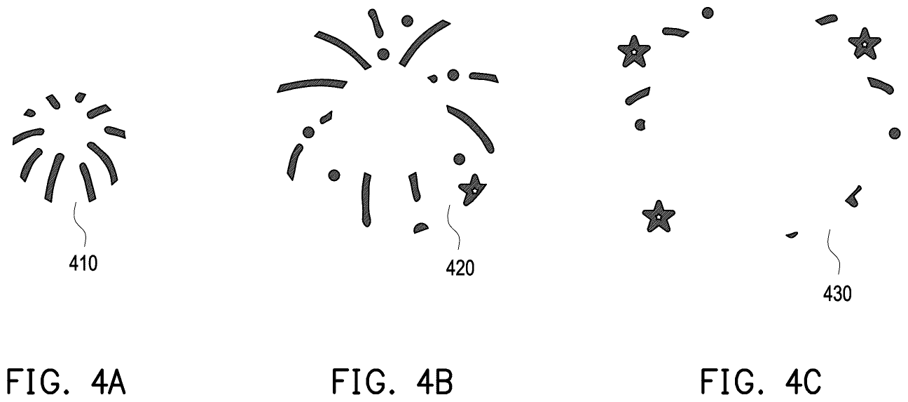

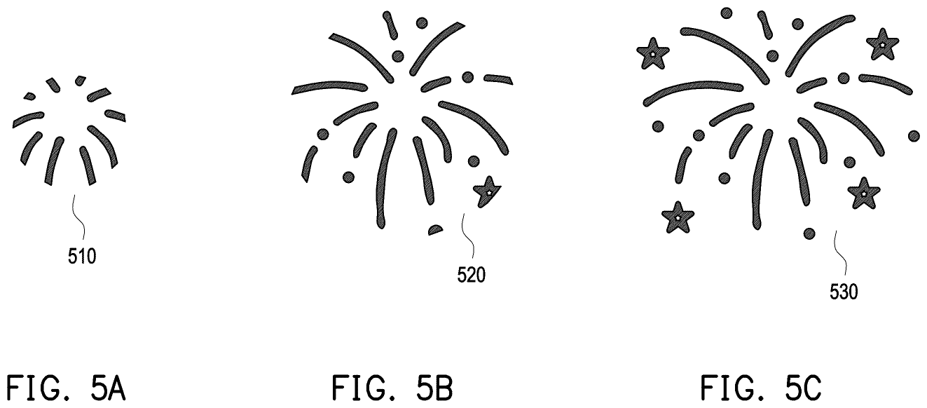

Firework photography will be used to illustrate below, but it is not limited thereto. FIG. 4A to FIG. 4C are schematic diagrams of the input frame in the original video signal obtained by shooting fireworks according to an embodiment of the present invention. FIG. 5A to FIG. 5C are schematic diagrams of the result frame obtained based on the original video signal according to an embodiment of the present invention. FIG. 4A to FIG. 4C show three consecutively obtained input frames 410, 420, and 430. FIG. 5A to FIG. 5C show three consecutive result frames 510, 520, and 530. Wherein, the input frame 410 is directly used as the result frame 510. The image-overlaying operation is performed on the input frame 410 and the input frame 420 to obtain the result frame 520. The image-overlaying operation is performed on the input frame 410 to the input frame 430 to obtain the result frame 530.

It can be known from FIG. 5A to FIG. 5C, through the image-overlapping operation, while maintaining the specified frame rate, the firework smear effect caused by a simulated long exposure can also be output, and there is no need to change the sense of time by time-lapse. Therefore, it is possible to retain the dynamic feeling of fireworks while forming a firework trajectory that is presented as a dynamic long exposure result. Firework photography is used as an example for convenience of explanation, and the scope of actual application should not be limited to the embodiment.

In summary, the disclosure uses the video signal originally shot with a short exposure through the image-overlaying operation to obtain the video signal that can simulate the effect of a long exposure. In this way, it cannot affect the smoothness of video playback, but also have a beautiful feeling.

What is claimed is:

1. A method for adjusting video signal, comprising:
obtaining N consecutive input frames obtained by an imaging apparatus by a processor; and
generating N result frames based on the N input frames and generating a video signal based on the N result frames by the processor,
wherein the step of generating the N result frames comprises:
storing a first input frame of the N input frames as a first result frame; and
selecting multiple input frames of the N input frames according to a time sequence as a source for image-overlaying of an i-th result frame, performing an image-overlaying operation on the selected multiple input frames to obtain the i-th result frame, and storing the i-th result frame, wherein i=2, 3, 4, . . . , N.

2. The method for adjusting video signal according to claim 1, further comprises:
based on a frame rate, determining a time interval of simulated exposure for each of the N result frames.

3. The method for adjusting video signal according to claim 1, wherein before performing the image-overlaying operation on the multiple input frames, further comprises:
performing an image alignment operation or an image stabilization process on the multiple input frames of the source for image-overlaying of the i-th result frame.

4. The method for adjusting video signal according to claim 1, wherein the source for image-overlaying of the i-th result frame comprises Mᵢ input frames, 1<Mᵢ≤i, the step of performing the image-overlaying operation on the multiple input frames comprises:
for the first input frame to the Mᵢ−1 input frame respectively, retaining one or more pixels with a brightness value greater than a first preset value; and
overlaying the retained pixels from the first input frame to the Mᵢ−1 input frame to the Mᵢ input frame to obtain the i-th result frame.

5. The method for adjusting video signal according to claim 1, wherein the source for image-overlaying of the i-th result frame comprises Mᵢ input frames, 1<Mᵢ≤i, the step of performing the image-overlaying operation on the multiple input frames comprises:
for the first input frame to the Mᵢ−1 input frame respectively, retaining one or more pixels with a saturation value greater than a second preset value; and
overlaying the retained pixels from the first input frame to the Mᵢ−1 input frame to the Mᵢ input frame to obtain the i-th result frame.

6. The method for adjusting video signal according to claim 1, wherein the step of performing the image-overlaying operation on the multiple input frames comprises:
summing up and averaging each pixel of the multiple input frames to obtain the i-th result frame.
